(19) United States
(12) Patent Application Publication
(10) Pub. No.: US 2006/0288673 A1
(43) Pub. Date: Dec. 28, 2006

(54) VELOCITY STACK AIR FILTRATION ASSEMBLY

(76) Inventor: Lee S. Wimmer, Perkasie, PA (US)

Correspondence Address: GREGORY J. GORE, 70 WEST OAKLAND AVENUE, SUITE 316, DOYLESTOWN, PA, 18901, US

(21) Appl. No.: 11/160,494

(22) Filed: Jun. 27, 2005

(51) Int. Cl. B01D 46/00

(52) U.S. Cl. 55/385.3

(57) ABSTRACT

In an internal combustion engine, an air filtration assembly provides a large frustoconical air filter positioned within an intake velocity stack affixed to its mouth. The air filter medium is located along the inside walls of the velocity stack throughout a substantial portion of its length. A funnel plate secures the filter to the body of the velocity stack and directs incoming air into the center of the filter. Air filtration surface area is maximized while providing a concealed air filter assembly that does not detract from the aesthetic appearance of the velocity stack.

### FIELD OF THE INVENTION

The present invention relates to intake air filtration for an internal combustion engine, more specifically to air filtration for a velocity stack used in conjunction with a motorcycle engine carburetor.

### BACKGROUND OF THE INVENTION

Various methods are known for improving engine performance by increasing the amount of air-fuel mixture delivered to the engine combustion chambers. One method of maximizing the efficiency of moving the desired volume of air-fuel mix into the engine combustion chamber is to apply a velocity stack to the intake side of the carburetor. Performance is enhanced when the velocity stack is properly shaped and sized with respect to the carburetor throat area so that air flow is maximized. While velocity stacks have shown to increase engine performance, providing air filtration to the velocity stack with motorcycles has been problematic.

Typically air intake velocity stacks have been run open without filters, however this can create problems when particulate matter such as sand and dirt enter the engine. A simple mesh filter has been employed, however such mesh filters reduce the effect of cross-sectional area of the velocity stack and also tend to clog quickly, degrading engine performance. Furthermore, because many mesh filters are external to the velocity stack, they are visible and many motorcycle owners find them aesthetically objectionable.

To solve these problems, it is known to employ filtration devices within the velocity stack which avoids the problem of the external mesh filters and does not detract from the appearance of the motorcycle because the filter is not visible. An example of such a filter is disclosed in U.S. Pat. No. 6,824,583 entitled “Velocity Stack Air System for Motorcycles.” Another such device is disclosed in U.S. Pat. No. 5,868,808 issued to Henderson entitled “Velocity Stack Filter.” This document discloses a carburetor air intake velocity stack which includes a shaped mesh filter having an effective open area which exceeds the open area of the velocity stack by at least 50 percent. The filter is located within the air intake velocity stack and has a cylindrically formed flange which is trapped between the velocity stack and the carburetor. The Henderson filter is cone-shaped with the base of the cone positioned directly adjacent the carburetor intake opening. While the Henderson device increases the filtration surface area, it nonetheless does not utilize the greatest amount of filtration surface area possible inside the velocity stack.

### SUMMARY OF THE INVENTION

It is therefore the object of the present invention to maximize air filtration within an internally concealed air filtration medium in a velocity stack. It is a further object of the invention to create a velocity stack air filtration assembly which is economical to produce and easy to maintain and install.

In order to meet these objectives, the present air filtration assembly has been devised. As described in greater detail below, the air filtration assembly provides a large frustoconical air filter which is attached to the mouth of the velocity stack with the larger base end of the air filter secured around the periphery of the inside wall of the velocity stack directly adjacent its opening. This places the air filter medium along the inside walls of the velocity stack throughout a substantial portion of its length. A funnel plate secures the filter to the body of the velocity stack and directs air into the center of the filter. With this configuration, the air filtration surface area is maximized while providing a concealed air filter assembly that does not detract from the aesthetic appearance of the velocity stack. When used on a motorcycle engine the velocity stack is preferably positioned out in the air stream facing forward so that a ram air effect is achieved. This pressurization of the intake air compensates for the air flow restriction imposed by the filter.

From the following drawings and description of the preferred embodiment, it will be appreciated by those of skill in the art that the objects of the invention have been achieved. While the present invention will be described with the reference to a specific embodiment, the following description is illustrative of the invention and is not to be construed as limiting the invention. Various modifications to the present invention can be made to the preferred embodiment by those skilled in the art without departing from the true spirit and scope of the invention. It will be noted here that for better understanding like components are designated by the reference numerals throughout the various figures of drawing which follow.

### BRIEF DESCRIPTION OF THE DRAWINGS

FIG. 1 is a top left front assembly perspective view.

FIG. 2 is a top left front perspective view.

FIG. 3 is a side sectional view taken from FIG. 2 as shown in that figure.

### DESCRIPTION OF THE PREFERRED EMBODIMENT

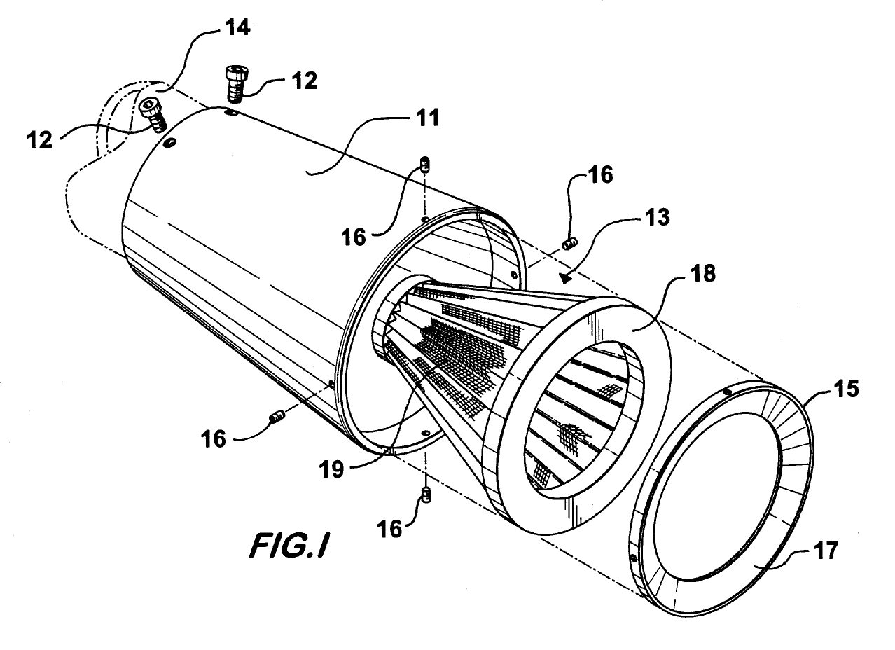

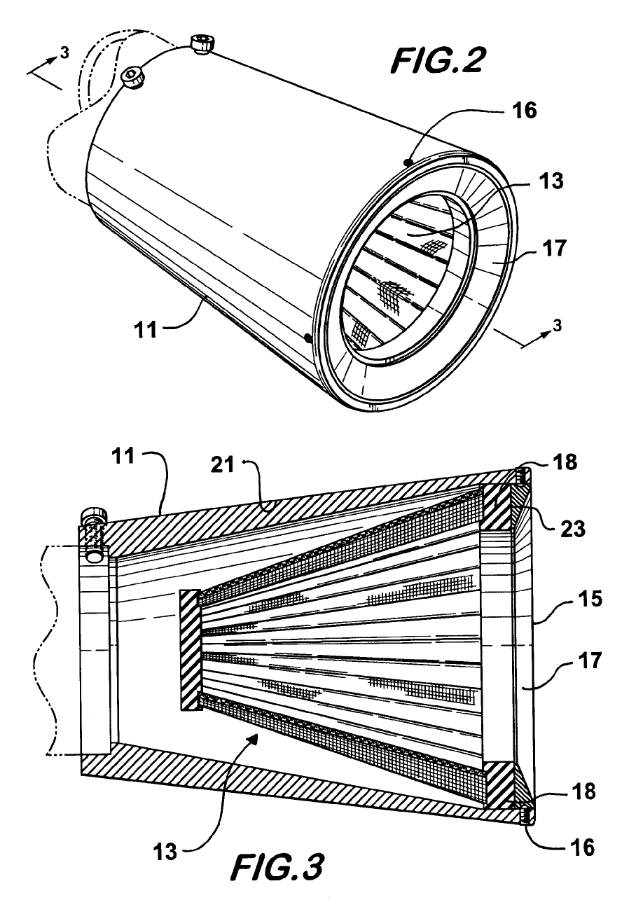

Referring now to FIGS. 1 and 2, the present invention includes three major components: an intake velocity stack 11, an air filter 13, and a funnel plate 15. The velocity stack 11 is affixed to a motorcycle engine combustion intake manifold 14 by screws 12. The air filter 13 is held in compression between the end of the velocity stack 11 and the funnel plate 15, the funnel plate being held in position by set screws 16 which are located around the periphery of the end of the velocity stack. The filter is of the type generally known which has a frustoconical filtering element which is bonded to elastomeric gaskets or rings at opposite ends. The filtering medium may be mesh, cloth, or paper, the particular specific filter medium composition in itself forming no part of the invention. These components are shown in their assembled condition in FIG. 2. The funnel plate 15 preferably includes a concave front surface 17 to direct the air flow inwardly.

Referring now to FIG. 3, an elastomeric ring or gasket 18 around the end of the air filter is held in compression between the inner wall 21 of the velocity stack 11 and an interior face 23 of the funnel plate 15 such that the filter is held firmly in position and centered within the velocity stack. As shown in this drawing, the sides of the filter are more steeply convergent in the direction of the air flow than the sidewalls of the velocity stack, however the walls of the filter lie substantially along the inner wall of the velocity stack a small distance from it.

It should be understood that there may be other modifications and changes to the present invention that will be obvious to those of skill in the art from the foregoing description, however, the present invention should be limited only by the following claims and their legal equivalents.

What is claimed is:

1. An air filter assembly for an air intake velocity stack affixed to a carburetor of an internal combustion engine, comprising:
a frustoconical air filter having a larger diameter upstream end and a smaller diameter downstream end; and
means for affixing said filter within said velocity stack such that said larger diameter end lies adjacent a mouth of said velocity stack which is open to the atmosphere and wherein a filter medium lies along a substantial portion of an inside wall of said velocity stack.

2. The air filter assembly of claim 1 further including a frustoconical funnel plate affixed to said velocity stack mouth, said plate being convergent in the direction of an intake air flow.

3. The air filter assembly of claim 1 wherein said means for affixing said filter within said velocity stack is by direct attachment to an interior surface of said funnel plate.

4. The air filter assembly of claim 2 wherein said funnel plate is affixed to said velocity stack by screws.

5. The air filter assembly of claim 1 wherein said engine is a motorcycle engine.

6. The air filter assembly of claim 5 wherein said velocity stack is forward-facing and positioned in the air stream created by the forward motion of the motorcycle.

7. The air filter assembly of claim 1 wherein said filter medium is located a spaced distance from said velocity stack inner wall.
